(19) United States
(12) Patent Application Publication
(10) Pub. No.: US 2009/0170961 A1
(43) Pub. Date: Jul. 2, 2009

(54) METHOD OF MANUFACTURING DYSPROSIUM OXIDE NANOPARTICLES AND METHOD OF MANUFACTURING DYSPROSIUM OXIDE NANOSOL

(75) Inventors: Jin Hyuck YANG, Suwon (KR); Chang Hwan Choi, Seongnam (KR); Byoung Jin Chun, Suwon (KR); Chul Tack Lim, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/248,063

(22) Filed: Oct. 9, 2008

(30) Foreign Application Priority Data
Dec. 28, 2007 (KR) 10-2007-0140551

(51) Int. Cl. C01F 17/00; B01F 3/12

(52) U.S. Cl. 516/33; 423/263

(57) ABSTRACT

Disclosed are a method of manufacturing dysprosium oxide nanoparticles and a method of manufacturing a dysprosium oxide nanosol, which can prepare dysprosium oxide particles having a size of tens of nanometers with high yield by using a simple, low-cost process. The method of manufacturing dysprosium oxide nanoparticles includes preparing a dysprosium salt solution by dissolving a dysprosium salt in a solvent; impregnating an organic polymer comprising a nanosized pore with the dysprosium salt solution; and heating the organic polymer impregnated with the dysprosium salt solution until the organic polymer is fired.

### CROSS-REFERENCE TO RELATED APPLICATIONS

This application claims the priority of Korean Patent Application No. 2007-140551 filed on Dec. 28, 2007, in the Korean Intellectual Property Office, the disclosure of which is incorporated herein by reference.

### BACKGROUND OF THE INVENTION

1. Field of the Invention

The present invention relates to a method of manufacturing dysprosium oxide nanoparticles and a method of manufacturing a dysprosium oxide nanosol, and more particularly, to a method of manufacturing dysprosium oxide nanoparticles and a method of manufacturing a dysprosium oxide nanosol, which can prepare dysprosium oxide particles having a size of tens of nanometers with high yield by using a simple, low-cost process.

2. Description of the Related Art

As products are developed to have smaller sizes and slimmer profiles with higher capacity, a process of preparing fine particles of a raw material becomes more important and is considered as a core technique in a product manufacturing process.

For example, when a multilayer ceramic capacitor (MLCC) is manufactured, barium titanate (BaTiO₃) is used as a main component of a dielectric, and an additive (mainly, a metal oxide) is also used to affect chip characteristics of the MLCC. To increase electrostatic capacitance of the MLCC, not only the barium titanate but also the additive needs to be prepared as fine particles, uniformly dispersed as primary particles and stably maintain their dispersion state.

In due consideration of the fact that an average particle size of the barium titanate being widely used in a slim and high capacity MLCC is about 150 nm, an additive must have a particle size of tens of nanometers to desirably coat a surface of the barium titanate. Also, to manufacture the slim and high capacity MLCC, composition uniformity of an internal electrode and a dielectric layer must be maintained, and pore formation in the dielectric must be prevented. Thus, the main component of the dielectric and the additive must be prepared as fine particles and dispersion thereof must be stabilized.

An oxide of a rare earth metal such as dysprosium (Dy) is an additive used in the MLCC to improve long-term reliability of the MLCC by reducing mobility of oxygen. Also, because of physical and chemical properties of rare earth metals, they are used for various applications such as optical glass, an abrasive material, a fluorescent material, a functional optical material, a pigment, a magnetic material, a magnetic bubble memory material, a metal additive, high-temperature high-strength ceramics, a reactor structure, a moderator, a hydrogen-containing material in the entire industrial field including electronics, metal, chemistry and nuclear power.

An example of a method of manufacturing dysprosium oxide includes a top-down method. In the top-down method, a dysprosium oxide precursor having a primary average particle size of about 100 nm to about 200 nm is made into slurry and the slurry is ground into smaller particles by using a grinding machine. That is, the top-down method is a method in which powder having a particle size greater than a desired particle size is ground into smaller-sized particles.

If a particle size of the dysprosium oxide precursor is small, particles having a size of tens of nanometers can be easily obtained, but the precursor is undesirably expensive. If a precursor with a great particle size is used, a grinding process for obtaining smaller particles is complicated. Also, even after the grinding process, the ground particles may have undesired shapes or aggregate with one another. FIG. 1 shows a field emission scanning electron microscope (FE-SEM) image of dysprosium oxide manufactured by a related art method. Referring to FIG. 1, dysprosium oxide particles exist aggregating with each other, and shapes and sizes thereof are not uniform.

To cope with the aforementioned limitations, an aerosol method or a method of decomposing a precursor with microwave plasma has been proposed for preparation of the dysprosium oxide. However, those proposed methods have limitations in particle-size control since they are also the top-down method employing a principle of grinding powder into smaller particles.

Even if the dysprosium oxide is used as an additive in smaller amount as compared to another raw material as in the MLCC, the dysprosium oxide is an essential additive having a significant effect for its added amount. Thus, the dysprosium oxide significantly affects the overall performance or quality of a product.

However, it is difficult to prepare dysprosium oxide particles having a size of 30 nm or less to have a desired shape by using the related art method. Therefore, there is a need for a simpler process by which dysprosium oxide particles having a desired size and shape can be prepared.

### SUMMARY OF THE INVENTION

An aspect of the present invention provides a method of manufacturing dysprosium oxide nanoparticles and a method of manufacturing a dysprosium oxide nanosol, which can prepare dysprosium oxide particles having a size of tens of nanometers with high yield by using a simple, low-cost process.

According to an aspect of the present invention, there is provided a method of manufacturing dysprosium oxide nanoparticles, the method including: preparing a dysprosium salt solution by dissolving a dysprosium salt in a solvent; impregnating an organic polymer including a nanosized pore with the dysprosium salt solution; and heating the organic polymer impregnated with the dysprosium salt solution until the organic polymer is fired.

The dysprosium salt solution may be a dysprosium nitrate (Dy(NO₃)₂) solution. The dysprosium salt solution may have a concentration ranging from 5 wt % to 15 wt %.

When the organic polymer is impregnated with the solution containing the dysprosium salt, heating may be performed to fire the organic polymer. The heating the organic polymer may be performed at a temperature ranging from 600° C. to 900° C. The heating the organic polymer may be performed for 30 minutes to 5 hours. The heating the organic polymer is performed at a heating rate of 2° C./h to 20° C./h.

The pore of the organic polymer may have a size on a nanoscale, ranging from 1 nm to 9 nm. The dysprosium oxide nanoparticles manufactured by the method of manufacturing dysprosium nanoparticles may have a size ranging from 20 nm to 40 nm.

The method may further include drying the organic polymer impregnated with the dysprosium salt solution before the heating the organic polymer.

The method may further include milling a heating residue after the heating the organic polymer.

According to another aspect of the present invention, there is provided a method of manufacturing a dysprosium oxide nanosol, the method including: preparing a dysprosium salt solution by dissolving a dysprosium salt in a solvent; impregnating an organic polymer having a nanosized pore with the dysprosium salt solution; heating the organic polymer impregnated with the dysprosium salt solution until the organic polymer is fired; milling a heating residue; and dispersing the milled heating residue in an organic solvent. The organic solvent may be ethanol.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a FE-SEM image of dysprosium oxide particles prepared by a related art method;

FIG. 2 is a view showing that dysprosium oxide particles are trapped within respective pores of an organic polymer according to an embodiment of the present invention;

FIG. 3 is a graph showing a result of particle-size analysis with respect to the number of dysprosium oxide nanoparticles prepared by the method of manufacturing dysprosium oxide nanoparticles according to the embodiment of the present invention;

FIG. 4 is a graph showing XRD data of dysprosium oxide nanoparticles prepared by the method of manufacturing dysprosium oxide nanoparticles according to the embodiment of the present invention; and

FIG. 5 is an SEM image of dysprosium oxide nanoparticles prepared by the method of manufacturing dysprosium oxide nanoparticles according to the embodiment of the present invention.

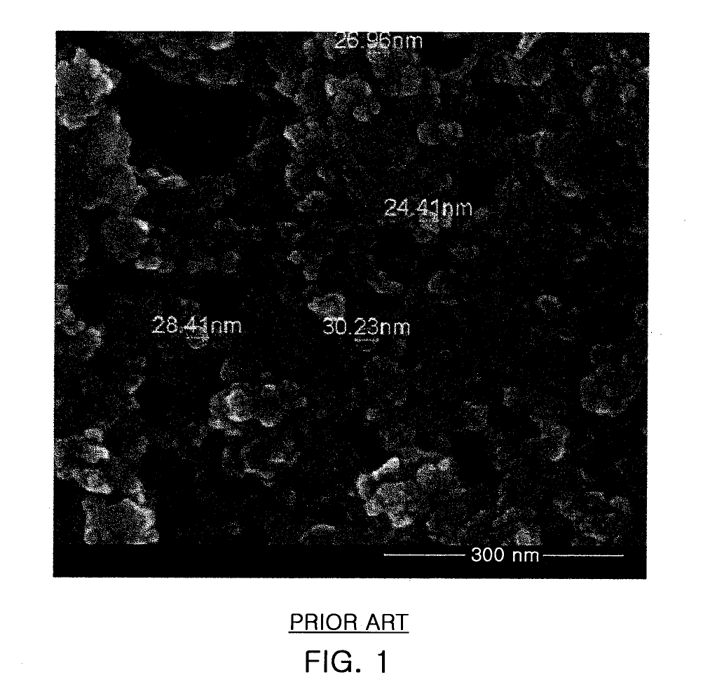

### DETAILED DESCRIPTION OF THE PREFERRED EMBODIMENT

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

A method of manufacturing dysprosium oxide nanoparticles according to an embodiment of the present invention includes: preparing a dysprosium salt solution by dissolving a dysprosium salt in a solvent; impregnating an organic polymer having a nanosized pore with the dysprosium salt solution; and heating the organic polymer impregnated with the dysprosium salt solution until the organic polymer is fired.

First, to prepare dysprosium oxide (Dy₂O₃), a solution containing a dysprosium salt (hereinafter, referred to as a dysprosium salt solution) is prepared.

The dysprosium salt solution used in the current embodiment of the present invention is not particularly limited. However, the dysprosium salt solution must be used for impregnation of an organic polymer and the dysprosium salt must be oxidized to dysprosium oxide at a firing temperature of the organic polymer.

The solvent may be water or an organic solvent. When the solvent is water, the dysprosium salt solution may contain nitric acid. In this case, the dysprosium salt solution may be dysprosium nitrate (Dy(NO₃)₂) aqueous solution. The concentration of the solution is determined in due consideration of a pore characteristic of the organic polymer to be impregnated. For example, the concentration of the dysprosium nitrate solution may range from 5 wt % to 15 wt %.

If the concentration is lower than 5 wt %, the amount of dysprosium salt acting as a precursor of dysprosium oxide becomes insufficient, resulting in low yield of the dysprosium oxide, which is an end product. If the concentration exceeds 15 wt %, a disparity between a limited number of pores of the organic polymer and the number of nanoparticles to be trapped therein may occur, undesirably resulting in aggregation of the nanoparticles.

After the dysprosium salt solution is prepared, the organic polymer having nanosized pores is impregnated with the dysprosium salt solution. The organic polymer may have pores of a predetermined size such as a pulp-type fiber texture. Particularly, the organic polymer usable in the embodiment of the present invention may have nanosized pores, so that particles on the nanoscale can be generated. For example, the organic polymer may be cellulose which is an organic compound in plants. The cellulose has chemical formula (C₆H₁₀O₆)ₙ, and generates carbon dioxide (CO₂) and water (H₂O) when heated.

The term ‘nanosized’ in the ‘nanosized pores’ refers to a size of a few nanometers. The dysprosium salt, which is a precursor of dysprosium oxide, is trapped within the nanosized pores of the organic polymer before the dysprosium salt becomes the dysprosium oxide. Thus, the prepared dysprosium oxide has a particle size of tens of nanometers. Hence, the pore size of the organic polymer may range from 1 nm to 9 nm.

According to the current embodiment of the present invention, to prepare dysprosium oxide nanoparticles, the organic polymer with the nanosized pores is impregnated with the solution containing the dysprosium salt, and nanosized dysprosium salt particles are trapped within the respective pores of the organic polymer.

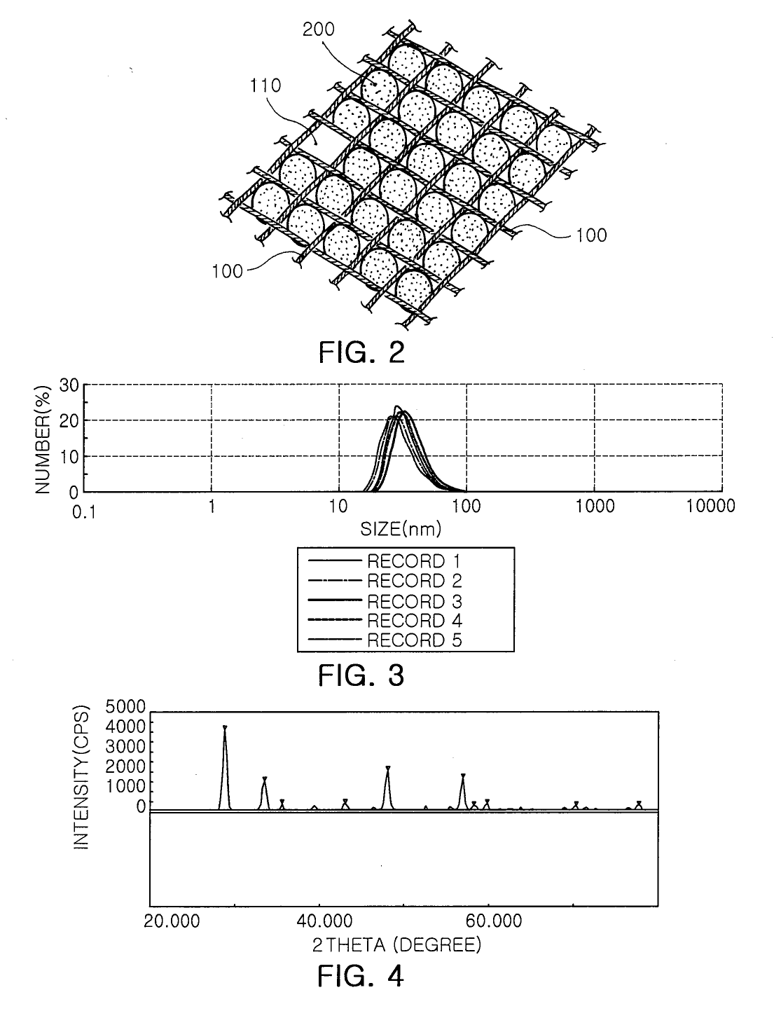

FIG. 2 is a view showing that dysprosium salt particles 200 are trapped within respective pores 110 of an organic polymer 100 according to the embodiment of the present invention. The dysprosium salt particles 200 exist in the size of a few nanometers, trapped within the respective nanosized pores 110 of the organic polymer 100.

Since the dysprosium salt particles 200 are respectively trapped within the pores 110 of the organic polymer 100, the dysprosium salt particles 200 do not aggregate at the time of reaction. Since the precursor itself exists in the size of a few nanometers, resultant dysprosium oxide particles can have the size of tens of nanometers. Also, the dysprosium oxide particles can be controlled so as to have uniform shapes.

The dysprosium oxide nanoparticles prepared by the above method of manufacturing dysprosium oxide nanoparticles according to the current embodiment have a size of tens of nanometers. For example, the particle size of the dysprosium oxide may range from 20 nm to 40 nm.

After the organic polymer is impregnated with the dysprosium salt solution, the organic polymer is heated. As mentioned above, when heated, the organic polymer (e.g., (C₆H₁₀O₆)ₙ) generates CO₂ and H₂O. Thus, the organic polymer can be removed by heating.

The organic polymer impregnated with the dysprosium salt component may be heated at a temperature ranging from 600° C. to 900° C. for 30 minutes to 5 hours. Also, the heating may be performed at a heating rate of 2° C./h to 20° C./h.

The method of manufacturing dysprosium oxide nanoparticles according to the current embodiment of the present invention may further include drying the organic polymer impregnated with the dysprosium salt solution before the heating of the organic polymer. If the organic polymer is impregnated with an excessive amount of dysprosium salt, a dysprosium crystal or salt larger than the nanoscale may be generated on a surface of the organic polymer. Therefore, the drying method or another method may be used to remove the excessive amount of dysprosium salt solution.

The method of manufacturing dysprosium oxide nanoparticles according to the current embodiment of the present invention may further include cooling a heating residue resulting from the heating and milling the cooled heating residue. After the dysprosium oxide nanoparticles are prepared by using the organic polymer, the milling may be performed to make the dysprosium oxide nanoparticles have a uniform size.

After the milling operation, particle-size analysis is performed. If a result of the particle-size analysis indicates that dysprosium oxide nanoparticles having a desired size and shape are prepared, the milling operation is stopped, and the dysprosium oxide nanoparticles are collected. In such a manner, uniform dysprosium oxide nanoparticles of a desired size are obtained. At this time, secondary particles resulted from aggregation of first particles may also exist. To achieve more uniform particle-size distribution, a centrifuge may be used to remove the secondary particles and obtain only the first particles.

According to another embodiment of the present invention, a method of manufacturing a dysprosium oxide nanosol includes: preparing a dysprosium salt solution by dissolving a dysprosium salt in a solvent; impregnating an organic polymer having a nanosized pore with the dysprosium salt solution; heating the organic polymer impregnated with the dysprosium salt solution until the organic polymer is fired; milling a heating residue from the heating; and dispersing the milled heating residue in an organic solvent. The organic solvent may be ethanol.

To obtain the heating residue, i.e., dysprosium oxide powder, the organic polymer impregnated with the dysprosium salt solution is fired by heating the organic polymer. Then, the dysprosium oxide powder is milled and dispersed in a predetermined solvent, thereby preparing nanosol of uniform particles. Ethanol may be used in preparing the nanosol. If it is difficult to disperse the milled dysprosium oxide particles in the predetermined solvent, a dispersant such as a surfactant is used. The surfactant may be an organic polymer-based surfactant.

FIG. 3 is a graph showing a result of particle-size analysis with respect to the number of dysprosium oxide nanoparticles prepared by the method of preparing dysprosium oxide nanoparticles according to the embodiment of the present invention.

The particle-size analysis of the dysprosium oxide nanoparticles is performed five times on the same dysprosium oxide nanoparticles, and average particle sizes are calculated with respect to the cumulative number. The result thereof is shown in the following Table 1.

TABLE 1

| | Cumulative number (%) | | | |
|---|---|---|---|---|
| | 10 | 50 | 90 | 99.9 |
| Record 1 | 23.2 nm | 31.1 nm | 46.3 nm | 101 nm |
| Record 2 | 21.4 nm | 29.3 nm | 45.1 nm | 102 nm |
| Record 3 | 25.5 nm | 34.9 nm | 52.4 nm | 113 nm |
| Record 4 | 23.9 nm | 32.2 nm | 48.7 nm | 101 nm |
| Record 5 | 20.3 nm | 27.9 nm | 43.2 nm | 100 nm |
| Average | 22.86 nm | 31.08 nm | 47.14 nm | 103.4 nm |

Referring to Table 1, it can be seen that dysprosium oxide nanoparticles having a uniform particle size are generated since 10% to 50% of the dysprosium oxide nanoparticles with respect to the number of nanoparticles have a size of about 23 nm to about 31 nm.

FIG. 4 is a graph showing XRD data of the dysprosium oxide nanoparticles prepared by the method of manufacturing dysprosium oxide nanoparticles according to the embodiment of the present invention. Referring to FIG. 4, it can be seen that nanoparticles prepared by the method of manufacturing dysprosium oxide nanoparticles are dysprosium oxide (Dy₂O₃).

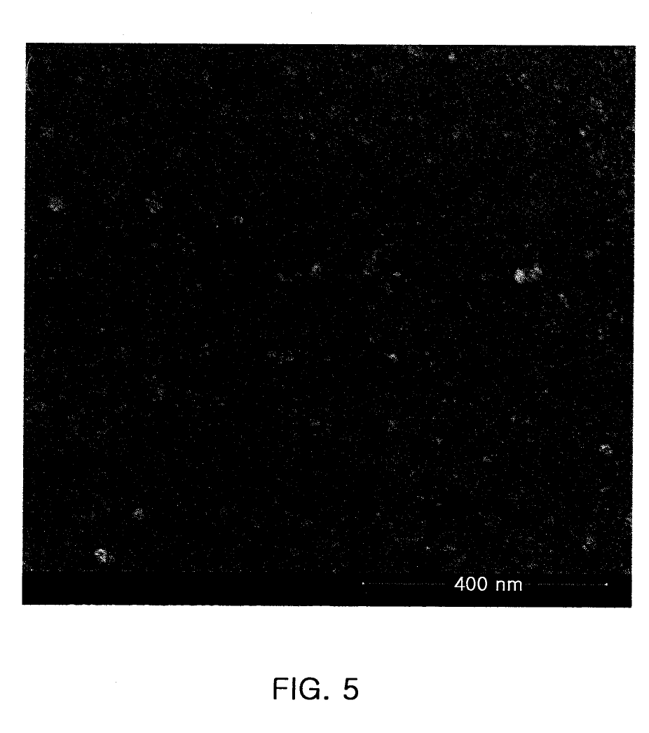

FIG. 5 is a scanning electron microscope (SEM) image of dysprosium oxide nanoparticles prepared by the method of manufacturing dysprosium oxide nanoparticles according to the embodiment of the present invention. Referring to FIG. 5, a result of observing surfaces of the prepared dysprosium oxide nanoparticles can be checked.

It can be seen from FIG. 5 that the dysprosium oxide nanoparticles have relatively uniform circular shapes because aggregation of the nanoparticles does not occur, and are clearly distinguished from one another. It can also be seen that the dysprosium oxide nanoparticles have a uniform size.

Hence, it is confirmed that dysprosium oxide nanoparticles each of which is distinctive and having an average size of about 30 nm are manufactured by the method of manufacturing dysprosium oxide nanoparticles according to the embodiment of the present invention.

According to the present invention, nanoparticles of a metal oxide such as vanadium (V), magnesium (Mg) or yttrium (Y) can be obtained with high yield by the same method. Also, if an oxide is prepared using Dy and at least one metal material selected among V, Mg and Y by the method of manufacturing nanoparticles according to the present invention, nanoparticles of a composite metal oxide can be obtained. Like the dysprosium oxide, an oxide of V, Mg or Y is used usefully as an addictive for a dielectric composition of a capacitor and in other various fields.

As described so far, according to the present invention, dysprosium oxide particles having a size of tens of nanometers can be effectively manufactured by using a low-priced precursor.

Also, uniform dysprosium oxide nanoparticles with desired shapes can be manufactured by controlling the shapes of the dysprosium oxide nanoparticles of tens of nanometers. Also, the dysprosium oxide nanoparticles can be obtained using a simple process.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing dysprosium oxide nanoparticles, the method comprising:
preparing a dysprosium salt solution by dissolving a dysprosium salt in a solvent;
impregnating an organic polymer comprising a nanosized pore with the dysprosium salt solution; and
heating the organic polymer impregnated with the dysprosium salt solution until the organic polymer is fired.

2. The method of claim 1, wherein the dysprosium salt solution is a dysprosium nitrate (Dy(NO₃)₂) solution.

3. The method of claim 1, wherein the dysprosium salt solution has a concentration ranging from 5 wt % to 15 wt %.

4. The method of claim 1, wherein the heating the organic polymer is performed at a temperature ranging from 600° C. to 900° C.

5. The method of claim 1, wherein the heating the organic polymer is performed for 30 minutes to 5 hours.

6. The method of claim 1, wherein the heating the organic polymer is performed at a heating rate of 2° C./h to 20° C./h.

7. The method of claim 1, wherein the pore of the organic polymer has a size ranging from 1 nm to 9 nm.

8. The method of claim 1, wherein the dysprosium oxide nanoparticles have a size ranging from 20 nm to 40 nm.

9. The method of claim 1, further comprising drying the organic polymer impregnated with the dysprosium salt solution before the heating the organic polymer.

10. The method of claim 1, further comprising milling a heating residue after the heating the organic polymer.

11. A method of manufacturing a dysprosium oxide nanosol, the method comprising:
preparing a dysprosium salt solution by dissolving a dysprosium salt in a solvent;
impregnating an organic polymer having a nanosized pore with the dysprosium salt solution;
heating the organic polymer impregnated with the dysprosium salt solution until the organic polymer is fired;
milling a heating residue; and
dispersing the milled heating residue in an organic solvent.

12. The method of claim 11, wherein the organic solvent is ethanol.
